(19) United States
(12) Patent Application Publication
(10) Pub. No.: US 2005/0213860 A1
(43) Pub. Date: Sep. 29, 2005

(54) Rolling bearing having ceramic rolling element and steel inner or outer ring

(75) Inventor: Xiao Bo Zhou, Nieuwegein (NL)

Correspondence Address: THE WEBB LAW FIRM, P.C., 700 KOPPERS BUILDING, 436 SEVENTH AVENUE, PITTSBURGH, PA, 15219, US

(73) Assignee: AS SKF, Gotenborg (SE)

(21) Appl. No.: 10/502,678

(22) PCT Filed: Jan. 30, 2003
(86) PCT No.: PCT/NL03/00066

§ 371 Date: Apr. 14, 2005

(30) Foreign Application Priority Data
Jan. 30, 2002 (NL) 1019860

(51) Int. Cl. F16C 33/62; F16C 33/32

(52) U.S. Cl. 384/492

(57) ABSTRACT

Disclosed is a roller bearing comprising an inner and outer ring, a number of rolling elements and a cage. The inner and outer ring comprise steel material and the rolling element a ceramic material. Either the inner or the outer ring is coated with a solid lubricant coating. The solid lubricant coating comprises a metal doped molybdenum disulfide.

The invention relates to a roller bearing comprising at least an inner or outer ring, a number of rolling elements and a cage, said inner or outer ring comprising ball bearing steel material and said rolling element comprising a ceramic material, wherein said inner or outer ring is coated with a solid lubricant coating

In many rolling bearing applications fluid lubricants such as grease and oil are not allowed to use. An example is a reactor of a polyethene processing plant, inside a CO₂ dyeing vessel for textile processing, vacuum and clean room environments for semi-conductor processing, instruments operated at ultra-high vacuum and aero-space. In these cases grease and/or oil particles could be highly contaminating and are not acceptable. However, if such rolling bearings run in a dry environment without fluid lubricant premature failure or even seizure might be expected due to adhesive wear, cold welding and heat generation from the high friction resulting.

To solve this problem the use of solid lubricant coatings has been proposed. Examples are PTFE coatings, molybdenum disulfide MoS₂ coatings, graphite coatings and diamond like carbon (DLC) coatings.

In the abstract of the Japanese patent application 03255224 the use of molybdenum disulfide on the raceway rings is disclosed.

DLC and (metal doped) MoS₂ have a strong adhesion to a steel substrate, with higher hardness, significant lower friction coefficient and therefore much higher wear resistance than those of conventional solid lubricants. Furthermore particle generation of such solid lubricant coatings is relatively low and there is no outgassing from the solid lubricants making them especially suitable for instruments operated at ultra-high vacuum and in clean room environments.

It is known in the art to coat roller elements with these solid lubricant coatings to improve service life of rolling bearings running under dry conditions.

However, it revealed that under severe circumstances such as in applications for pumps, sliding contacts and gears still premature damage can be observed.

Molybdenum disulfide as such is relatively soft material and has a low wearing resistance. It cannot withstand height loadings. In the atmosferic conditions errosion is a serious problem.

The invention aims to provide a rolling bearing to be used without a fluid lubricant which has improved loading properties.

According to the invention this aim is realised in that said solid lubricant coating comprises metal doped MoS₂.

According to the invention a rolling bearing is proposed having an inner and/or outer ring of ball bearing steel being provided with as metal doped MoS₂. To the use of metal doped MoS₂ a more particular titanium doped molybdenum disulfide the hardness of the lubricant considerably increases to getting with this wear resistance. The hardness of molybdenum disulfide as such has been found to be around 200 HV. If a metal is added hardnesses of 1000-2000 HV can be realised. Because of the presence of the metal in the molybdenum disulfide protection against oxidation is obtained.

The metal used such as titanium is preferably present in the quantity of 2-20% by weight and more particular about 10% by weight. The rolling element comprises a ceramic element. An example is a Si₃N₄ ceramic material.

The cage for the rolling element can comprise both a plastic and a metallic material. This is dependent from the surroundings in which the rolling bearing is used. Under extreme conditions a metallic cage being realised through powder metallic techniques would also be a feasible option.

Although the invention might be realised with a rolling element comprising a ball, according to a preferred embodiment the rolling element comprises a roller

If a metal doped MoS₂ coating is used it will be understood that such coating is realised in a number of layers.

If a MoS₂ layer has to be provided on a steel substrate titanium is used as intermediate layer. So in this case a number of layers (10-100) can be provided.

According to a preferred embodiment of the invention the total coating thickness so obtained is between 0,1 and 4 micron and more particular between 1 and 2 micron. Depositing (PVD) is realised on the finished bearing component i.e. no further grinding or rehardening is effected after deposition of the coating.

The metallic inner or outer ring can comprise stainless steel material, i.e. steel having increased chromium and nickel content.

The ceramic material rolling element can also be coated with a solid lubricant coating.

1-8. (canceled)

9. A roller bearing comprising:
at least an inner or outer ring,
a number of rolling elements, and
a cage,
wherein said inner or outer ring comprises ball bearing steel material and each of said rolling elements comprises a ceramic material,
and said inner or outer ring is coated with a solid lubricant coating, said solid lubricant coating comprising metal doped MoS₂.

10. The roller bearing according to claim 9, wherein said metal comprises titanium.

11. The roller bearing according to claim 9, wherein 2-20% by weight metal is provided in said lubricant coating.

12. The roller bearing according to claim 9, wherein each of said rolling elements comprises a Si₃N₄ material.

13. The roller bearing according to claim 9, wherein each of said rolling elements comprises a roller.

14. The roller bearing according to claim 9, wherein said inner or outer ring comprises a stainless steel.

15. The roller bearing according to claim 9, wherein said rolling elements are coated with a solid lubricant coating.

16. The roller bearing according to claim 9, further comprising lubricant grease.
